(19) United States
(12) Patent Application Publication
(10) Pub. No.: US 2010/0118155 A1
(43) Pub. Date: May 13, 2010

(54) DIGITAL IMAGE PROCESSING APPARATUS

(75) Inventor: Jin-gi Lee, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/614,609

(22) Filed: Nov. 9, 2009

(30) Foreign Application Priority Data
Nov. 12, 2008 (KR) 10-2008-0112208

(51) Int. Cl. H04N 5/228

(52) U.S. Cl. 348/208.5; 348/E05.031

(57) ABSTRACT

Provided is a digital image processing apparatus which can reduce the level of noise that is caused by a hand shake correcting operation of a hand shake correction mechanism and is recorded when sound is recorded. The digital image processing apparatus includes: a hand shake detecting unit installed in a main body and measuring hand shake resulting in movement of the main body during photographing; a hand shake correcting unit correcting the hand shake and generating hand shake correction sound due to its hand shake correcting operation; a recording unit receiving external sound to be recorded; and a control unit controlling the hand shake correcting unit to reduce the hand shake correction sound when the recording unit records the received external sound.

### CROSS-REFERENCE TO RELATED PATENT APPLICATION

This application claims the benefit of Korean Patent Application No. 10-2008-0112208, filed on Nov. 12, 2008, in the Korean Intellectual Property Office, the entire contents of which is incorporated herein by reference.

### BACKGROUND OF THE INVENTION

1. Field of the Invention

The disclosure of a digital image processing apparatus relates to a digital image processing apparatus including a hand shake correction unit and a microphone for recording sound.

2. Description of the Related Art

Examples of a digital image processing apparatus include a digital camera, a personal digital assistant (PDA), a phone camera, and a personal computer (PC) camera which process an image or use an image sensor.

A digital image processing apparatus displays images, which are received from an image pickup device, on an image display device, and allows a user to capture a desired image and store the captured desired image in an image file format.

A user's hand may shake while capturing images, for example taking pictures or movies, with a digital image processing apparatus resulting in a blurry image being captured. A digital image processing apparatus may include a hand shake correction device that compensates for the hand shake in order to improve the quality of the captured image. The hand shake correction device may generate noise by moving mechanical parts. Additionally, the digital image processing apparatus may provide the ability to record sound while capturing images, which may provide the user with more enjoyment by permitting the user to hear the recorded sounds while viewing the captured images.

Users of the digital image processing device may want the image quality improved by compensating for hand shake and may want to record sound while recording the images.

### SUMMARY OF THE INVENTION

Therefore, there is a need in the art for a digital apparatus including a recording unit configured to record sound; a hand shake detecting unit configured to measure hand shake and generate a hand shake signal indicative of the measured hand shake; and a hand shake correcting unit configured to correct the hand shake based on the hand shake signal and configured to reduce an amount of noise generated in correcting hand shake when the recording unit is recoding sound.

The digital image processing apparatus may include a lens and lens control unit. The lens control unit may be configured to move the lens. The hand shake correcting unit may be configured to correct the hand shake by moving the lens based on the hand shake signal.

The hand shake correcting unit may reduce the amount of noise generated in correcting hand shake by reducing the movement the lens.

The digital image processing apparatus may be configured to adjust a recording level of the recording unit based on the amount of noise generated by the hand shake correcting unit.

The digital image processing apparatus may include a zoom adjusting unit configured to adjust a zoom level of an input image signal, wherein the apparatus is configured to adjust a recording level of the recording unit according to the zoom level.

According to another aspect of the present invention, there is provided a digital image processing apparatus comprising: a hand shake detecting unit installed in a main body and generating a hand shake signal by measuring hand shake resulting in movement of the main body during photographing; a hand shake correcting unit correcting the hand shake and generating hand shake correction sound due to its hand shake correcting operation; a recording unit receiving external sound to be recorded; and a control unit controlling the hand shake correcting unit, by receiving the hand shake signal, to reduce the hand shake correction sound when the recording unit records the received external sound.

The hand shake detecting unit may comprise: a hand shake detecting sensor detecting the hand shake; and an amplifier amplifying a signal detected by the hand shake detecting unit and generating a hand shake signal.

The hand shake detecting sensor may be at least one of an angular velocity sensor and an acceleration sensor.

The hand shake correcting unit may comprise: an operating unit operating in order to correct the hand shake; an operation detecting sensor detecting the operation of the operating unit; an amplifier amplifying a signal detected by the operation detecting sensor and generating an operation detection signal; and an operation driving unit driving the operating unit.

The control unit may receive the hand shake signal and the operation detection signal, generate an operation signal for driving the operating unit in order to correct the hand shake, and output the operation signal to the operation driving unit.

The operation detecting sensor may be a position sensor that detects the position of the lens or the image pickup device.

The recording unit may comprise: a microphone receiving the external sound; and a microphone control unit adjusting a recording gain that determines a recording level of the external sound received by the microphone.

The control unit may generate a microphone control signal, which comprises the recording gain that is determined according to the hand shake correction sound, and output the microphone control signal to the microphone control unit.

The control unit may comprise: a hand shake correction amount calculating unit calculating a hand shake correction amount from the hand shake signal and the operation detection signal which are converted into digital signals; an operation gain adjusting unit adjusting an operation gain of the operating unit to reduce the hand shake correction sound when the recording unit records the received external sound; and a recording control unit outputting a microphone control signal for controlling a recording level of recorded sound.

The recording control unit may control the operation gain adjusting unit to adjust the operation gain when the recording unit records the received external sound.

The recording control unit may determine a recording gain that determines the recording level according to at least one of a zoom level of a zoom lens, external noise, and the operation gain.

The digital image processing apparatus may further comprise a storage unit storing a gain database of the operation gain and the recording gain that is determined according to at least one of the zoom level and a level of the external noise, wherein the recording gain and the operation gain are determined from the gain database.

Accordingly, the digital image processing apparatus can reduce the level of noise that is caused by a hand shake correcting operation of a hand shake correction mechanism and is recorded when sound is recorded.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front and the top of an example of a digital image processing apparatus, e.g., a digital camera′

FIG. 2 illustrates the back of the digital image processing apparatus of FIG. 1;

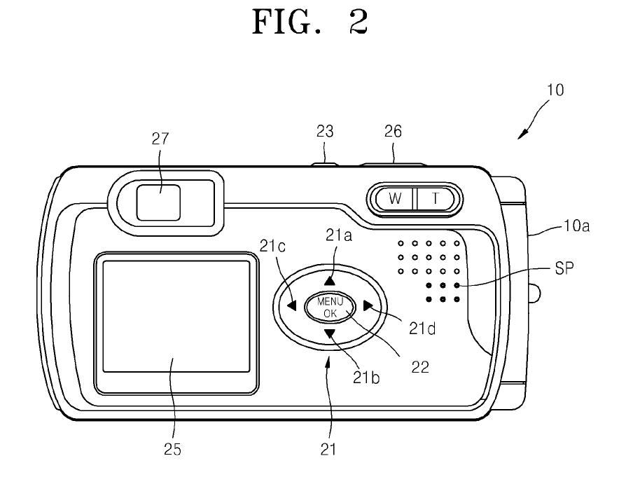

FIG. 3 is a block diagram of an example of a control device included in the digital image processing apparatus of FIG. 1;

FIG. 4 is a block diagram of an example of a digital image processing apparatus; and

FIG. 5 is a block diagram of an example of a control unit of the digital image processing apparatus of FIG. 4.

### DETAILED DESCRIPTION OF THE INVENTION

The disclosure of the digital image processing apparatus will now be described more fully with reference to the accompanying drawings, in which exemplary embodiments are shown.

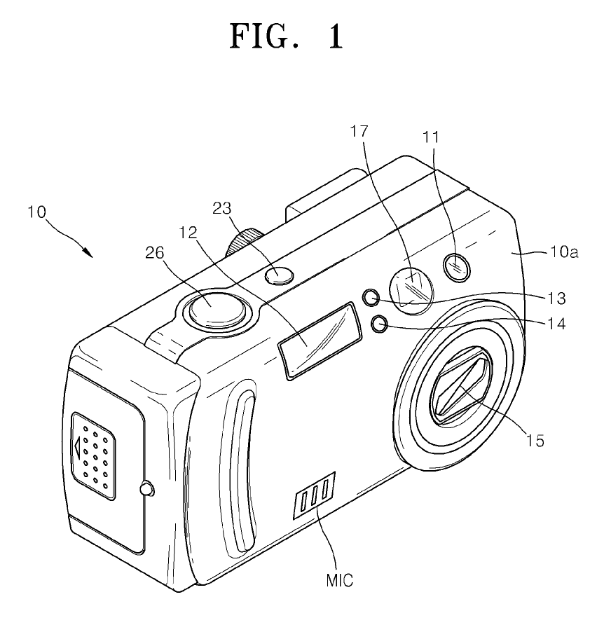

FIG. 1 is a perspective view illustrating the front and the top of an example of a digital image processing apparatus 10, e.g., a digital camera, according to an embodiment of the disclosure of a digital image processing apparatus.

Referring to FIG. 1, in the front and the top, the digital image processing apparatus 10 includes a self-timer lamp 11, a flash 12, a flash-light amount sensor 13, a remote receiving unit 14, a lens unit 15, a front surface 17 of a view finder, a power switch 23, a shutter button 26, and a microphone MIC.

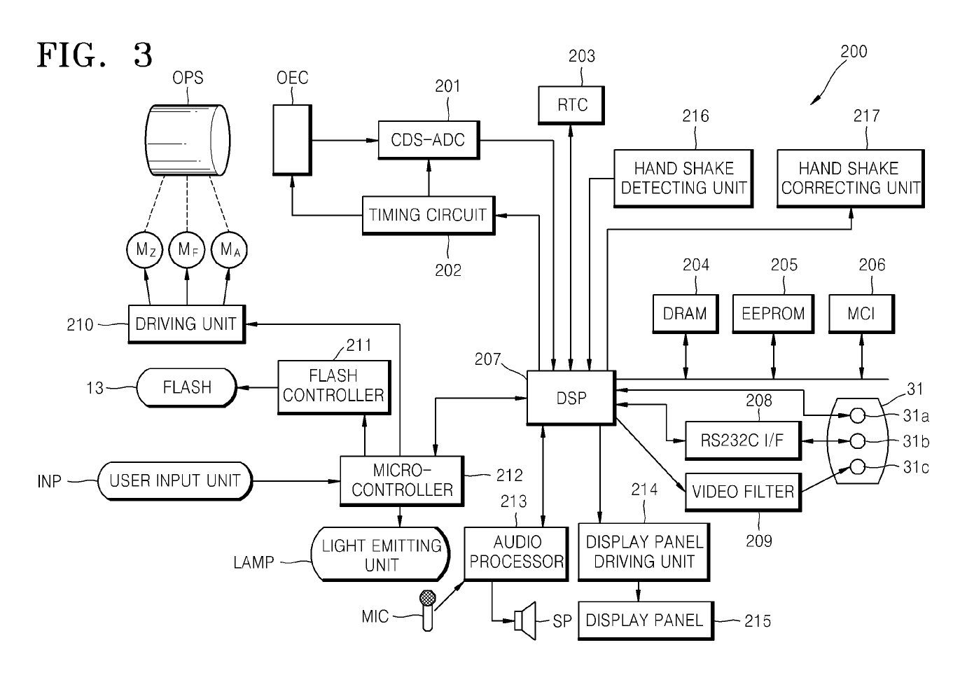

In a self-timer mode, the self-timer lamp 11 operates for a predetermined period of time from when the shutter button 26 is pressed to when the shutter button 26 starts to operate. When the flash 12 operates, the flash-light amount sensor 13 senses the amount of light, and inputs the sensed amount of light to a digital signal processor DSP 207 (see FIG. 3) by using a micro-controller 212 (see FIG. 3).

The remote receiving unit 14 receives a command signal, for example, a photographing command signal, from a remote controller (not shown) and inputs the received command signal to the digital signal processor DSP 207 by using the micro-controller 212.

Sound may be input through the microphone MIC. The sound input through the microphone MIC may be recorded by the micro-controller 212 and/or the digital signal processor DSP 207 and then stored in a storage medium.

The microphone MIC may be disposed in the front of a main body 10a in order to receive sound coming from a subject. The microphone MIC of FIG. 1 may correspond to a microphone MIC of FIG. 3.

In the inside of the main body 10a, the digital image processing apparatus 10 may include a hand shake detecting unit 216 and a hand shake correcting unit 217 (see FIG. 3). The hand shake detecting unit 216 may detect a handshake resulting in movement of the main body 10a, and the hand shake correcting unit 217 may correct the hand shake. The hand shake correcting unit 217 may move a lens or an image pickup device in order to correct the hand shake by operating a driving unit including a motor. Noise may be caused by a hand shake correcting operation of the hand shake correcting unit 217.

Sound generated by the subject may be input through the microphone MIC and then be recorded. The hand shake correcting operation may be performed while the sound generated by the subject is recorded. In this case, the noise caused by the correcting of the hand shake may be input through the microphone MIC and recorded along with the sound generated by the subject which is desired to be recorded by a user.

In general, sound caused by the hand shake correcting operation may be noise, not sound desired to be recorded. Accordingly, if recording is performed while the hand shake correcting operation is performed, the noise caused by the hand shake correcting operation shake may be recorded along with the sound desired to be recorded.

The level of sound to be recorded may be reduced. However, in this case, not only the level of noise but also the level of desired sound are reduced.

Accordingly, since the digital image processing apparatus 10 of FIG. 1 controls the hand shake correcting unit 217 to reduce sound (referred to as hand shake correction sound hereinafter) caused by a hand shake correcting operation while recording is performed, the digital image processing apparatus 10 can reduce the level of the hand shake correction sound that is not desired by the user.

The digital image processing apparatus 10 can control the hand shake correcting unit 217 to reduce the hand shake correction sound, and accordingly can adjust a recording level of sound recorded by the microphone MIC. As a result, the hand shake correction sound can be reduced and the desired sound to be recorded by the user can be more clearly input and recorded.

An example of the back of the digital image processing apparatus 10 may include a direction button 21, a menu-OK button 22, a wide angle-zoom button W, a telephoto-zoom button T, a speaker SP, and a display panel 25.

The direction button 21 may include 4 buttons in total, that is, an up button 21a, a down button 21b, a left button 21c, and a right button 21d. The direction button 21 and the menu-OK button 22 are pressed to execute various menu items concerning the operation of the digital image processing apparatus 10.

The wide angle-zoom button W or the telephoto-zoom button T is pressed in order to widen or narrow the angle of view. In particular, the wide angle-zoom button W and the telephoto-zoom button T may be used to change the size of a selected exposure area. If the wide angle-zoom button W is pressed, the size of the selected exposure area may be increased, and if the telephoto-zoom button T is pressed, the size of the selected exposure area may be decreased.

The display panel 25 may be an image display device, such as a liquid crystal display (LCD). Sound input through and recorded by the microphone MIC may be output through the speaker SP.

An objective lens and an ocular lens may be respectively disposed on the front surface 17 and a rear surface 27 of the view finder which are respectively arranged in the front and the back of the digital image processing apparatus 10.

The shutter release button 26 is pressed to open and close a shutter in order to expose the image pickup device, such as a charge coupled device (CCD), or a film to light for a predetermined period of time. Also, the shutter release button 26 works in conjunction with an aperture (not shown) to properly expose the subject and record an image picked up by the image pickup device.

An example of a digital image processing apparatus and an example of an apparatus and method for controlling the same, to which the present invention can be applied, is disclosed in US Patent Publication No. 2004/0130650, entitled “Method of Automatically Focusing Using Quadratic Function in Camera,” the entire contents of which is incorporated herein by reference.

FIG. 3 is a block diagram of an example of a control device 200 included in the digital image processing apparatus of FIG. 1. The control device 200 may be installed in the digital image processing apparatus 10 of FIG. 1.

Referring to FIG. 3, an optical system OPS including a lens unit and a filter unit optically processes light bounding from a subject to be photographed. The lens unit of the optical system OPS includes a zoom lens, a focus lens, and a compensation lens. If the user presses the wide angle-zoom button W or the telephoto-zoom button T, which are included in a user input unit INP, a corresponding signal is input to the micro-controller 212. Then, the micro-controller 212 controls a lens driving unit 210 such that a zoom motor M_{Z} is driven to move the zoom lens. If the wide angle-zoom button W is pressed, a focal length of the zoom lens is reduced and thus the angle of view is widened, and if the telephoto-zoom button T is pressed, a focal length of the zoom lens is increased and thus the angle of view is narrowed.

In an auto focusing mode, a main controller embedded in the digital signal processor DSP 207 controls the lens driving unit 210 by using the micro-controller 212 to drive a focus motor M_{F} such that the focus motor M_{F} moves the focus lens to a position where a clearest image can be obtained.

The compensation lens is not additionally driven because the compensation lens compensates for an overall refractive index. An aperture motor M_{A} is used to drive the aperture (not shown).

The filter unit of the optical system OPS includes an optical low pass filter, which removes high-frequency optical noise, and an infrared cut filter, which blocks an infrared component of incident light.

A photoelectric converting unit OEC may include the image pickup device such as a CCD or a complementary metal oxide semiconductor (CMOS). The photoelectric converting unit OEC converts light received from the optical system OPS into an electrical analog signal.

An analog-digital converting unit may include a correlation double sampler and analog-to-digital converter (CDS-ADC) 201. The analog-digital converting unit processes the analog signal received from the photoelectric converting unit OEC to remove high frequency noise from the analog signal and adjusts an amplitude, and converts the analog signal into a digital signal. Here, the digital signal processor DSP 207 controls the operation of the analog-digital converting unit and the photoelectric converting unit OEC by controlling a timing circuit 202.

A real time clock RTC 203 provides time information to the digital signal processor DSP 207. The digital signal processor DSP 207 processes the digital signal received from the CDS-ADC 201 to generate a digital image signal including a brightness signal Y and color signals R, G, and B.

Examples of a light emitting unit LAMP, which is driven by the micro-controller 212 under the control of the main controller embedded in the digital signal processor DSP 207, may include a self-timer lamp, an auto-focus lamp, a mode indicator lamp, and a flash-ready lamp. The user input unit INP may include the direction button 21, the wide angle-zoom button W, and the telephoto-zoom button T.

A dynamic random access memory (DRAM) 204 may temporarily store the digital image signal received from the digital signal processor DSP 207. An electrically erasable and programmable read only memory (EEPROM) 205 stores setting data and methods, such as a booting program and a key input program, which are necessary for the operation of the digital signal processor DSP 207. A memory card may be attached to a memory card interface MCI 206.

A display panel driving unit 214A receives the digital image signal from the digital signal processor DSP 207, and the display panel 215 displays an image.

The digital image signal coming from the digital signal processor DSP 207 may be transmitted through a universal serial bus (USB) connection unit 31a, or an RS 232C interface 208 and a connection unit 31b over a serial communication network. Alternatively, the digital image signal may be transmitted as a video signal through a video filter 209 and a vide output unit 31c.

The digital signal processor DSP 207 may allow the micro-controller 212 to be embedded therein.

An audio processor 213 outputs an audio signal received from the microphone MIC to the digital signal processor DSP 207 or the speaker SP, and outputs an audio signal received from the digital signal processor DSP 207 to the speaker SP.

The hand shake detecting unit 216 may be installed in the main body 10a (see FIG. 1) and may measure a hand shake resulting in movement of the main body 10a during photographing. The hand shake correcting unit 217 may correct the hand shake by moving the lens unit or the image pickup device to compensate for hand shake detected by the hand shake detecting unit 216.

When the hand shake is corrected by moving the lens unit or the image pickup device, hand shake correction sound may be generated due to the operation of the driving unit 210 including the motor. Accordingly, the hand shake correction noise may be reduced by controlling the hand shake correcting unit 217 to reduce the hand shake correction noise during recording.

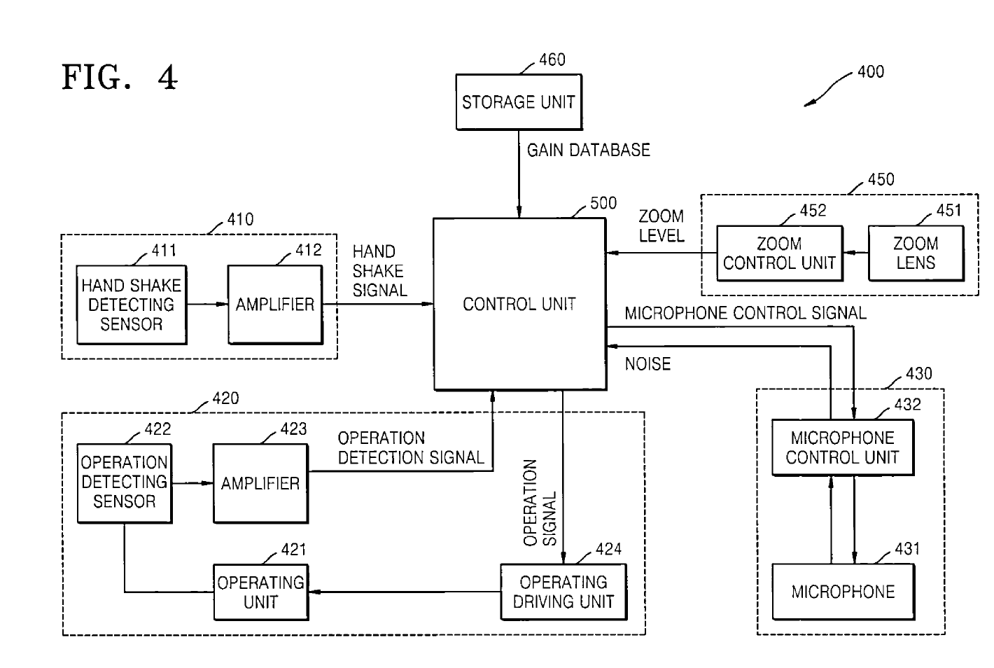

FIG. 4 is a block diagram of an example of a digital image processing apparatus 400 according to another embodiment of the disclosure of the digital image processing apparatus.

The digital signal processor DSP 207 and/or the micro-controller 212 of FIG. 3 may be included in an example of a control unit 500 of FIG. 4. The hand shake detecting unit 216 and the hand shake correcting unit 217 of FIG. 3 may correspond to a hand shake detecting unit 410 and a hand shake correcting unit 420 of FIG. 4, respectively.

The microphone MIC and the audio processor 213 of FIG. 3 may perform functions of a microphone 431 and a microphone control unit 432 included in a recording unit 430 of FIG. 4, respectively. The zoom lens and the driving unit 210 included in the lens unit may perform functions of a zoom lens 451 and a zoom control unit 452 included in a zoom adjusting unit 450 of FIG. 4, respectively.

At least one of memory cards recognized by the DRAM 204, the EEPROM 205, and the memory card interface MCI 206 may correspond to a storage unit 460 of FIG. 4.

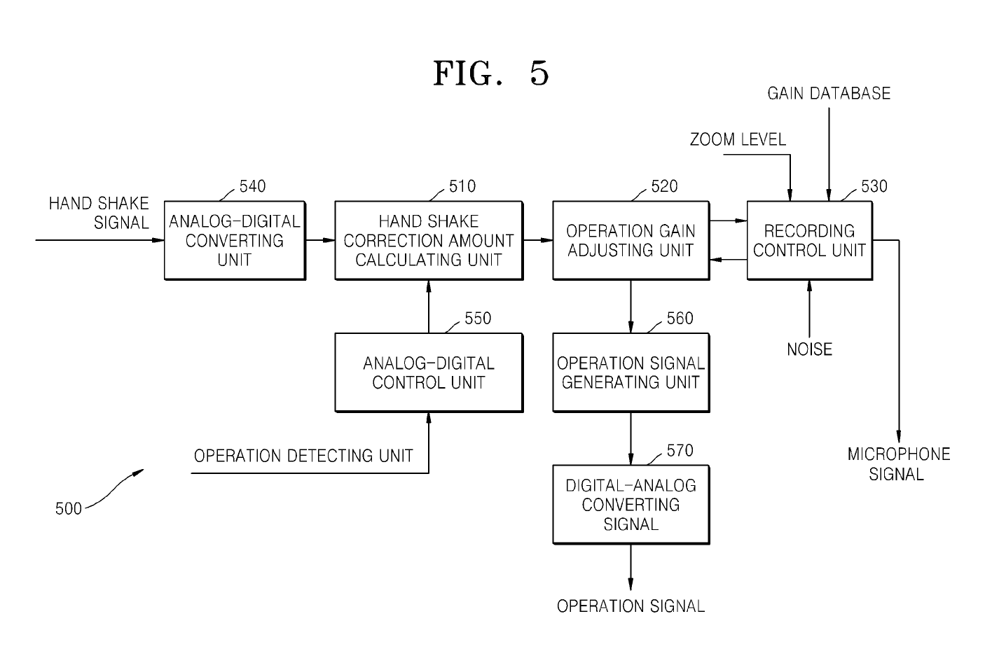

FIG. 5 is an example of a block diagram of the control unit 500 included in the digital image processing apparatus 400 of FIG. 4.

Referring to FIGS. 4 and 5, the digital image processing apparatus 400 may include the hand shake detecting unit 410, the hand shake correcting unit 420, the recording unit 430, the zoom adjusting unit 450, the storage unit 460, and the control unit 500.

The hand shake detecting unit 410 may be installed in the main body 10a (see FIG. 1) and may measure hand shake resulting in movement of the main body 10a during photographing. The hand shake correcting unit 420 for correcting the hand shake may generate hand shake correction noise due to its hand shake correcting operation.

The recording unit 430 may record external sound. The control unit 500 may control the hand shake correcting unit 420 to reduce the hand shake correction noise when the recording unit 430 performs recording. To reduce the correction noise, the control unit 500 may control the hand shake correcting unit 420 to reduce the hand shake correction sound by adjusting an operation gain corresponding to a control gain of the hand shake correcting unit 420.

If recording is performed while the hand shake correcting operation is performed, the control unit 500 may reduce the hand shake correction noise, which is not desired by the user, by controlling the hand shake correcting unit 420 to reduce the hand shake correction noise.

In addition or alternatively, the control unit 500 may control the recording unit 430 to adjust a recording level of the recording unit 430 according to the hand shake correction noise.

The digital image processing apparatus 400 of FIG. 4 can reduce the hand shake correction sound by controlling the hand shake correcting unit 420, and accordingly can adjust a recording level of sound recorded by the microphone MIC. As a result, the hand shake correction noise can be reduced and desired sound to be recorded by the user can be more clearly input and recorded.

The digital image processing apparatus 400 may further include the zoom adjusting unit 450 that adjusts a zoom level of an input image signal. The control unit 500 may control the recording unit 430 to adjust a recording level of the recording unit 430 according to the zoom level.

To this end, the zoom level may be divided into a plurality of zoom levels, and the recording level may be adjusted according to each of the plurality of zoom levels. For example, the zoom level may be divided into a wide angle zoom level, a middle zoom level, and a telephoto zoom level.

In the wide angle zoom level when the subject is likely located close to the digital image processing apparatus 400, the recoding level may be reduced, and in the telephoto zoom level when the subject is likely located far from the digital image processing apparatus 400, the recording level may be increased. In the middle zoom level between the wide angle zoom level and the telephoto zoom level, the recording level may be a middle value between the recording levels of the wide angle zoom level and the telephoto zoom level.

The recording level may be adjusted by adjusting a mic gain of the microphone 431 included in the recording unit 430. After mic gains may be previously obtained according to the plurality of zoom levels of the zoom level, arranged into a look up table, and stored in the storage unit 460, a mic gain corresponding to a current zoom level may be determined by referring to the look up table.

Accordingly, if the subject is located far from the image processing apparatus 400, recording may be performed by increasing the recording level, and if the subject is located close to the image processing apparatus 400, recording may be performed by reducing the recording level. The recording may be performed by varying the recording level to an appropriate level depending on the position of the subject.

Alternatively and/or in addition, the recording level of the recording unit 430 may be adjusted according to a level of external noise. That is, after a noise component is detected from sound input and recorded by the recording unit 430, the recording level may be adjusted according to the concentration of the noise component.

The hand shake detecting unit 410 for measuring hand shake during photographing may include a hand shake detecting sensor 411 and an amplifier 412. The hand shake detecting sensor 411 may detect the degree of the hand shake. The amplifier 412 may amplify a signal detected by the hand shake detecting sensor 411 and generate a hand shake signal.

The hand shake signal may be an analog signal indicating the degree of the hand shake. The hand shake detecting sensor 411 may be at least one of an angular velocity sensor and an acceleration sensor.

The hand shake correcting unit 420 for correcting the hand shake may include an operating unit 421, an operation detecting sensor 422, an amplifier 423, and an operation driving unit 424.

The operating unit 421 may operate in order to correct the hand shake. The operation detecting sensor 422 may detect the operation of the operating unit 421. The amplifier 423 may amplify a signal detected by the operation detecting sensor 422 and generate an operation detection signal. The operation driving unit 424 may drive the operating unit 421.

The control unit 500 may receive the hand shake signal and the operation detection signal, and generate an operation signal for driving the operating signal 421 in order to correct the hand shake. The operation signal generated by the control unit 500 may be input to the operation driving unit 424. The operation driving unit 424 may move the operating unit 421 according to the operation signal to correct the hand shake indicated by the hand shake signal.

In order to reduce hand shake correction noise, which is noise caused by the hand shake correcting operation, the control unit 500 may control the hand shake correcting unit 420 to reduce the hand shake correction sound by adjusting a control gain of the hand shake correcting unit 420.

The operating unit 421, which operates in order to correct the hand shake, may be the lens unit or the image pickup device of FIG. 3. The operation detecting sensor 422 may be a position sensor detecting the position of the lens unit or the image pickup device.

The recording unit 430, which receives and records external sound, may include the microphone 431 and the microphone control unit 432. The microphone 431 may receive sound. The microphone control unit 432, which controls the microphone 431, may adjust a recording gain that determines a recording level of sound input through the microphone 431.

The control unit 500 may generate a microphone control signal including the recording gain and output the generated microphone control signal to the microphone control unit 432. The recording gain may be determined according to the hand shake correction noise.

Alternatively, the recording gain may be determined by the hand shake correction noise and noise input through the recording unit 430. Alternatively, the recording gain may be determined according to at least one of the hand shake correction noise, noise input through the recording unit 430 and the zoom level of the zoom lens 451.

The control unit 500 may control the hand shake correcting unit 420 to reduce the hand shake correction noise when the recording unit 430 performs recording. To this end, the control unit 500 may receive the hand shake signal and generate an operation signal for controlling the hand shake correcting unit 420.

The control unit 500 may include a hand shake correction amount calculating unit 510, an operation gain adjusting unit 520, and a recording control unit 530.

The hand shake correction amount calculating unit 510 may calculate a hand shake correction amount from the hand shake signal and the operation detection signal which are converted into digital signals. The operation gain adjusting unit 520 may adjust an operation gain of the operating unit 421 to reduce the hand shake correction sound when sound input through the recording unit 430 is recorded.

The recording control unit 530 may output a microphone control signal for controlling a recording level of sound to be recorded. The recording control unit 530 may control the operation gain adjusting unit 520 to adjust an operation gain when sound input through the recording unit 430 is recorded.

The recording control unit 530 may determine a recording gain according to at least one of a zoom level of the zoom lens, external noise, and an operation gain. To this end, a gain database of an operation gain and a recording gain that is determined according to at least one of a zoom level and a noise level may be prepared in advance.

The gain database may be established experimentally in order to improve a recording level of sound to be recorded and to reduce hand shake correction sound. The digital image processing apparatus 400 may further include the storage unit 460 storing the gain database.

The hand shake detecting sensor 411 may detect hand shake, convert the detected hand shake into an angular velocity signal, amplify the angular velocity signal, generate a hand shake signal, and transmit the generated hand shake signal to the control unit 500. Since the hand shake signal input to the control unit 500 is an analog signal, an analog-digital signal converting unit 540 converts the analog signal into a digital signal.

The control unit 500 may determine a hand shake correction amount based on the hand shake signal and convert the hand shake correction amount into an analog signal through the operation gain adjusting unit 520, the operation signal generating unit 530, and a digital-analog converting unit 570 to generate an operation signal. The operating unit 421 is driven by the operation driving unit 424 according to the operation signal, thereby operating a hand shake correction mechanism.

The operation detecting sensor 422 detects the position of the operating unit 421 that is driven by the operation driving unit 424, and the amplifier 423 amplifies the detected position to generate an operation detection signal which is fed back to the control unit 500. Next, the hand shake correction amount calculating unit 510 calculates again the hand shake signal and the operation detection signal input thereto to calculate a hand shake correction amount again and generate a new operation signal. An analog-digital converting unit 550 converts the operation detection signal, which is input to the control unit 500, into a digital signal and the hand shake correction amount calculating unit 510 receives the digital signal from the analog-digital converting unit 550.

When the control unit 500 adjusts the operation gain in order to drive the operating unit 421, the operation gain adjusting unit 520 may be connected to the recording control unit 530 so that the operation gain and the recording gain can be automatically compared and adjusted.

The operation gain affects a driving power or a driving method of the operation driving unit 424 including the motor and thus affects a level of operation sound generated when the operating unit 421 is driven. Accordingly, the level of the operation gain directly affects the level of the operation sound generated when the hand shake correction mechanism operates.

The operation gain may become a gain of an actuator included in the operation driving unit 424. For example, the operation gain may be a servo gain, a loop gain, or a sensitivity gain. That is, each of these gains may be a control gain required to control the hand shake correcting unit 420.

The recording gain may be set by setting a gain of the microphone 431 through which sound is input. An adjustment range may be set by setting a lower limit and an upper limit of the recording gain so that the recording gain does not exceed the adjustment range. The recording gain and the operation gain of the hand shake correcting unit 420 may be set to be automatically compared and adjusted.

Accordingly, once the operation gain for controlling the operation driving unit 424 is adjusted, the recording gain of the microphone 431 may be automatically adjusted. The operation gain and the recording gain may be adjusted discretely according to preset steps.

The adjustment range of the recording gain may be greater than that of the operation gain. In this case, the operation gain may be adjusted in 10 steps from a step −5 to a step +5 (−5 ˜−1, 0, 1˜5), and the recording gain may be adjusted in 20 steps from a step −10 to a step +10 (−10 ˜−1, 0, 1˜10).

For example, if the operation gain is moved by one step in a negative direction, since the recording gain can be adjusted in a more steps, the recording gain may be moved by 2 steps in a negative direction. That is, if the operation gain is adjusted in a negative direction, the recording gain may be adjusted in a negative direction, and if the operation gain is adjusted in a positive direction, the recording gain may be adjusted in a positive direction.

Alternatively, if the operation gain is adjusted in a positive direction, the recording gain may be adjusted in a negative direction, and if the operation gain is adjusted in a negative direction, the recording gain may be adjusted in a positive direction. The latter may be used when if the operation gain is increased in a positive direction, a driving power of the operation driving unit 424 is increased and accordingly, operation sound is increased.

However, the present invention is not limited thereto and the size of a gain adjustment range and the number of steps may vary according to gain resolution. This may be determined by a designer.

The recording control unit 530 may determine the recording gain and the operation gain by referring to the gain database stored in the storage unit 460.

The operation gain may be input to the operation gain adjusting unit 520, and a signal according to a hand shake correction amount calculated by the hand shake correction amount calculating unit 510 may be amplified and input to an operation signal generating unit 560 to generate an operation signal.

A microphone control signal including the recording gain may be generated by the recording control unit 530 and input to the microphone control unit 432, and a signal input by the microphone may be controlled by the microphone control unit 432 according to the recording gain.

The digital image processing apparatus 400 of FIG. 4 can reduce hand shake correction sound, which is caused by a hand shake correcting operation and is not desired by the user, by controlling the hand shake correcting unit 420 to reduce the hand shake correction sound when recording is performed while the hand shake correction is performed.

Also, the digital image processing apparatus 400 of FIG. 4 can reduce the hand shake correction sound by controlling the hand shake correcting unit 420, and accordingly can adjust a recording level of sound recorded by the microphone MIC. Also, the digital image processing apparatus 400 can adjust a recording level by considering a zoom level and external noise. Accordingly, the hand shake correction sound can be reduced, and sound desired to be recorded by the user can be more clearly input and recorded.

The various illustrative units, logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A digital image processing apparatus, comprising:
a recording unit configured to record sound;
a hand shake detecting unit configured to measure hand shake and generate a hand shake signal indicative of the measured hand shake; and
a hand shake correcting unit configured to correct the hand shake based on the hand shake signal and configured to reduce an amount of noise generated in correcting hand shake when the recording unit is recoding sound.

2. The digital image processing apparatus of claim 1, further comprising:
a lens and lens control unit, the lens control unit configured to move the lens; and wherein the hand shake correcting unit is configured to correct the hand shake by moving the lens based on the hand shake signal.

3. The digital image processing apparatus of claim 2, wherein the hand shake correcting unit reduces the amount of noise generated in correcting hand shake by reducing movement of the lens in correcting hand shake.

4. The digital image processing apparatus of claim 1, wherein the apparatus is configured to adjust a recording level of the recording unit based on the amount of noise generated by the hand shake correcting unit.

5. The digital image processing apparatus of claim 1, further comprising:
a zoom adjusting unit configured to adjust a zoom level of an input image signal; and wherein the apparatus is configured to adjust a recording level of the recording unit according to the zoom level.

6. The digital image processing apparatus of claim 5, wherein the recording level is reduced when the zoom level is low, the low zoom level indicating a subject of the image is close to the digital image processing apparatus.

7. A digital image processing apparatus comprising:
a hand shake detecting unit installed in a main body and generating a hand shake signal by measuring hand shake resulting in movement of the main body during photographing;
a hand shake correcting unit correcting the hand shake and generating hand shake correction sound due to its hand shake correcting operation;
a recording unit receiving external sound to be recorded; and
a control unit controlling the hand shake correcting unit, by receiving the hand shake signal, to reduce the hand shake correction sound when the recording unit records the received external sound.

8. The digital image processing apparatus of claim 7, wherein the hand shake detecting unit comprises:
a hand shake detecting sensor detecting the hand shake; and
an amplifier amplifying a signal detected by the hand shake detecting unit and generating a hand shake signal.

9. The digital image processing apparatus of claim 8, wherein the hand shake detecting sensor is at least one of an angular velocity sensor and an acceleration sensor.

10. The digital image processing apparatus of claim 7, wherein the hand shake correcting unit comprises:
an operating unit operating in order to correct the hand shake;
an operation detecting sensor detecting the operation of the operating unit;
an amplifier amplifying a signal detected by the operation detecting sensor and generating an operation detection signal; and
an operation driving unit driving the operating unit.

11. The digital image processing apparatus of claim 10, wherein the control unit receives the hand shake signal and the operation detection signal, generates an operation signal for driving the operating unit in order to correct the hand shake, and outputs the operation signal to the operation driving unit.

12. The digital image processing apparatus of claim 11, wherein the control unit controls the hand shake correcting unit to reduce the hand shake correction sound by adjusting a control gain of the hand shake correcting unit.

13. The digital image processing apparatus of claim 10, wherein the operating unit is a lens or an image pickup device which is moved by the operation driving unit.

14. The digital image processing apparatus of claim 13, wherein the operation detecting sensor is a position sensor that detects the position of the lens or the image pickup device.

15. The digital image processing apparatus of claim 7, wherein the recording unit comprises:
a microphone receiving the external sound; and
a microphone control unit adjusting a recording gain that determines a recording level of the external sound received by the microphone.

16. The digital image processing apparatus of claim 15, wherein the control unit generates a microphone control signal, which comprises the recording gain that is determined according to the hand shake correction sound, and outputs the microphone control signal to the microphone control unit.

17. The digital image processing apparatus of claim 16, further comprising a zoom adjusting unit adjusting a zoom level of an input image signal,
wherein a recording gain of the recording unit is adjusted according to the zoom level.

18. The digital image processing apparatus of claim 16, wherein the control unit determines the recording gain according to the hand shake correction sound and noise input through the recording unit.

19. The digital image processing apparatus of claim 10, wherein the control unit comprises:
a hand shake correction amount calculating unit calculating a hand shake correction amount from the hand shake signal and the operation detection signal which are converted into digital signals;
an operation gain adjusting unit adjusting an operation gain of the operating unit to reduce the hand shake correction sound when the recording unit records the received external sound; and
a recording control unit outputting a microphone control signal for controlling a recording level of recorded sound.

20. The digital image processing apparatus of claim 19, wherein the recording control unit controls the operation gain adjusting unit to adjust the operation gain when the recording unit records the received external sound.

21. The digital image processing apparatus of claim 20, wherein the recording control unit determines a recording gain that determines the recording level according to at least one of a zoom level of a zoom lens, external noise, and the operation gain.

22. The digital image processing apparatus of claim 21, further comprising a storage unit storing a gain database of the operation gain and the recording gain that is determined according to at least one of the zoom level and a level of the external noise,
wherein the recording gain and the operation gain are determined from the gain database.
